(19) United States
(12) Patent Application Publication
(10) Pub. No.: US 2006/0220452 A1
(43) Pub. Date: Oct. 5, 2006

(54) Method for controlling the braking system of a motor vehicle

(75) Inventors: Andreas Emmerich, Oberusel (DE); Yasser Dayoub, Darmstadt (DE); Norbert Ehmer, Eschborn (DE); Alfred Eckert, Mainz-Hechtsheim (DE); Jochen Futhrer, Darmstadt (DE); Rene Huth, Friedrichsdorf (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/548,577

(22) PCT Filed: Mar. 10, 2004
(86) PCT No.: PCT/EP04/50279

§ 371 Date: Apr. 11, 2006

(30) Foreign Application Priority Data
Feb. 12, 2003 (DE) 10311129.8

(51) Int. Cl. B60T 8/64

(52) U.S. Cl. 303/152

(57) ABSTRACT

A method is used to control a brake system (1) including an electrically controllable generator (4) and a number of friction brakes (2) in such a fashion that high braking comfort can be achieved by means of the brake system (1). To this end, the total deceleration consists of a parallel configuration of deceleration components of the friction brakes (2) and the generator (4), the nominal brake torque of the generator (4) is determined by way of determining a total nominal deceleration and the generator (4) is controlled by means of this nominal brake torque.

### BACKGROUND OF THE INVENTION

The present invention relates to a method for controlling a brake system of a motor vehicle, in particular for controlling a regenerative brake system with a number of friction brakes and an electric generator for a motor vehicle. It further relates to a software module for controlling the method.

The purpose of regenerative brake systems in motor vehicles involves storing at least part of the energy produced during braking in the vehicle and re-using it for the drive of the vehicle. This allows reducing the energy consumption of the vehicle in total, increasing the efficiency, and thus rendering its operation more economical. To this effect, motor vehicles with a regenerative brake system generally include different types of brakes, which are also called brake actuators.

Typically, hydraulic friction brakes, as known from customary motor vehicles, and an electro-regenerative brake are employed in this arrangement. Like in conventional friction brakes, the brake pressure for the friction brakes is generated by means of a brake pressure generating means or by way of the brake pedal movement, respectively. The electro-regenerative brake is generally configured as an electric generator, through which at least part of the total brake output is generated. The produced electric energy is fed into a storage medium such as an on-board battery, or fed back, respectively, and is reused for the drive of the motor vehicle by way of an appropriate drive.

Regenerative brake systems can be designed as so-called serial regenerative concepts where the component of the brake torque which is produced by the generator is as high as possible. In contrast thereto, parallel or so-called residual-moment-based regenerative concepts are known, where the brake torque is distributed in predefined ratios to the brake actuators. In parallel brake systems of this type, typically, there exist deceleration components of both the generator and the friction brakes in all operating conditions. Mixed concepts of these two brake concepts are also known. It is common to all systems that several brake actuators are used for simultaneous braking at least in some ranges of the brake torque to be generated so that the total deceleration is composed of the deceleration components of the brake actuators.

So-called ‘brake-by-wire’ brake systems are principally known in serial regenerative brake systems. In ‘brake-by-wire’ brake systems, the braking energy is generally split up into components of the friction brakes and into components of the electric generator, said split-up being dependent on the nominal brake torque, the charging condition of the battery, and especially the field of operation and other special properties of the generator. Due to the split-up of braking energy, the brake pressure is built up independently of the hydraulic influence of the brake pedal in ‘brake-by-wire’ brake systems.

In conventional brake systems, however, which have only one friction brake, the brake pressure is built up depending on the position of the brake pedal. In this arrangement, the pressure of a braking medium is built up by way of the position of the brake pedal with or without auxiliary energy, the braking medium being received by the friction brake. Thus, the pedal position corresponds to the braking behavior of the motor vehicle. Exceptions can be the use of electronic safety systems such as the electric stability program (ESP), which can comprise devices for the independent brake pressure development irrespective of the brake pedal position.

Compared to a conventional brake system, a ‘brake-by-wire’ brake system entails high effort and structure and costs.

### SUMMARY OF THE INVENTION

In view of the above, an object of the invention is to disclose a method for controlling a brake system which includes an electrically controllable generator and a number of friction brakes so that high braking comfort can be achieved with a simple brake system. Another objective is to disclose a software module which is especially appropriate for implementing the method.

With respect to the method, this object is achieved by the invention because the total deceleration is composed of a parallel configuration of deceleration components of the friction brakes and the generator, and the nominal brake torque of the generator is determined by way of determining a total nominal deceleration, and the generator is controlled by way of this nominal brake torque.

The invention is based on the reflection that an acceptable pedal feel develops in a parallel braking method or brake system wherein in a braking operation the brake torque is composed of a parallel configuration of a generator brake torque and the brake torque of friction brakes. In this arrangement, the method shall prevent an active braking medium pressure so that there is no reactive effect on the brake pedal. Therefore, a braking request is converted into hydraulic braking medium pressure of the friction brakes, and the generator torque is superimposed on the braking torque, which results from an adaptation to the braking request. The position of the brake pedal corresponds to the braking performance of the motor vehicle because the total deceleration corresponds to the brake pressure of the hydraulic friction brake. The pressure of the friction brake, in turn, corresponds to the position of the brake pedal because a correspondingly higher amount of hydraulic fluid is urged from the brake pedal to the friction brakes e.g. when the brake torque is increased. The total nominal deceleration is determined for controlling the generator by way of a corresponding nominal brake torque. Subsequently, the nominal deceleration component of the generator can be determined by way of the deceleration component of the friction brakes, and the generator can be controlled on the basis thereof or, respectively, on the basis of the resulting nominal brake torque of the generator.

In order to demand the generator brake torque in particular only in its working range and not to overload the generator, the brake torque of the generator is favorably limited by a maximum brake torque in a selected speed range. Besides, it is thereby ensured that the brake torque component of the friction brakes in this speed range is still sufficient so that the brake pedal position corresponds in the best way possible to the braking performance of the motor vehicle.

Suitably, the range between 10 and 50 km/h is chosen as the speed range. Preferably, that torque is predefined as the maximum brake torque for the generator which corresponds to a contribution of the generator to the total deceleration of roughly 0.15 g. In general, the torque of an electric generator rises steeply at low speeds, especially between 10 and 20 km/h. In a brake torque limitation starting from 10 km/h, the brake torque of the generator is smoothed in a transition of the point of abrupt steep rise.

For a floating transition of the brake torque control of the generator at the fringes of the speed range, abrupt brake torque changes of the generator at the fringe of the speed ranges are preferably smoothed in order to avoid a negative reaction to the braking performance.

Advantageously, the generator is operated to be acting as soon as there is no positive acceleration of the motor vehicle. The driver therefore feels the deceleration effect of the generator as an additional engine brake, while braking by the friction of the engine can be performed in addition.

Preferably that torque is preset to the generator as an appropriate brake torque, which corresponds to a contribution of the generator to the total deceleration of approximately 0.1 g.

To determine the total nominal deceleration, this deceleration is suitably determined by means of a travel indicator of the brake pedal of the brake system. To determine the brake pressure which prevails at the brake pedal in a defined brake pedal position and can also be used for determining the total nominal brake torque, said brake pressure is determined preferably by way of a pressure sensor that is positioned at a hydraulic line of the brake system leading to a friction brake.

Still further signals can be used for determining the total nominal brake torque. Favorably, signals being available in the brake system are used. In this arrangement, signals are used in particular which are used for controlling safety systems such as ABS (anti-lock system), ESP (Electronic Stability Program), or ASC (anti-slip control) and are provided in the brake system.

For an appropriate control and an implementation of the method into a brake system, a brake system is appropriately controlled by way of a software module using a method described above. To this end, an electrically controlled brake system can also be extended by a software module of this type.

Preferably, a software module is a component part of a brake system of a motor vehicle.

The advantages achieved with the invention especially include the possibility of controlling a regenerative brake system in such a fashion that reasonable braking comfort is achieved, with the deceleration behavior of the motor vehicle corresponding to the position of the brake pedal. It is another advantage of the invention that the effort involved for realizing the brake system described is comparatively low. Thus, only an appropriate software module is required to control the brake system. Therefore, the brake system controlled by a software module has a very favorable cost-benefit ratio.

The comparatively low expenditure in additional brake system components which are required for controlling the brake system, and simple control operations also permit a high degree of reliability of the brake system.

It is another advantage that the software module can be retrofitted to electrically controllable brake systems. Both regenerative brake systems and conventional brake systems with friction brakes and an additional electric generator are feasible.

### BRIEF DESCRIPTION OF THE DRAWINGS

An embodiment is explained by way of FIGS. 1 to 2. In the drawings:

FIG. 1 shows a basic circuit diagram of a brake system (1), and;

FIG. 2 shows a brake operation, with proportionate brake torques of generator (4) and friction brakes (2) as a function of time.

### DETAILED DESCRIPTION OF THE DRAWINGS

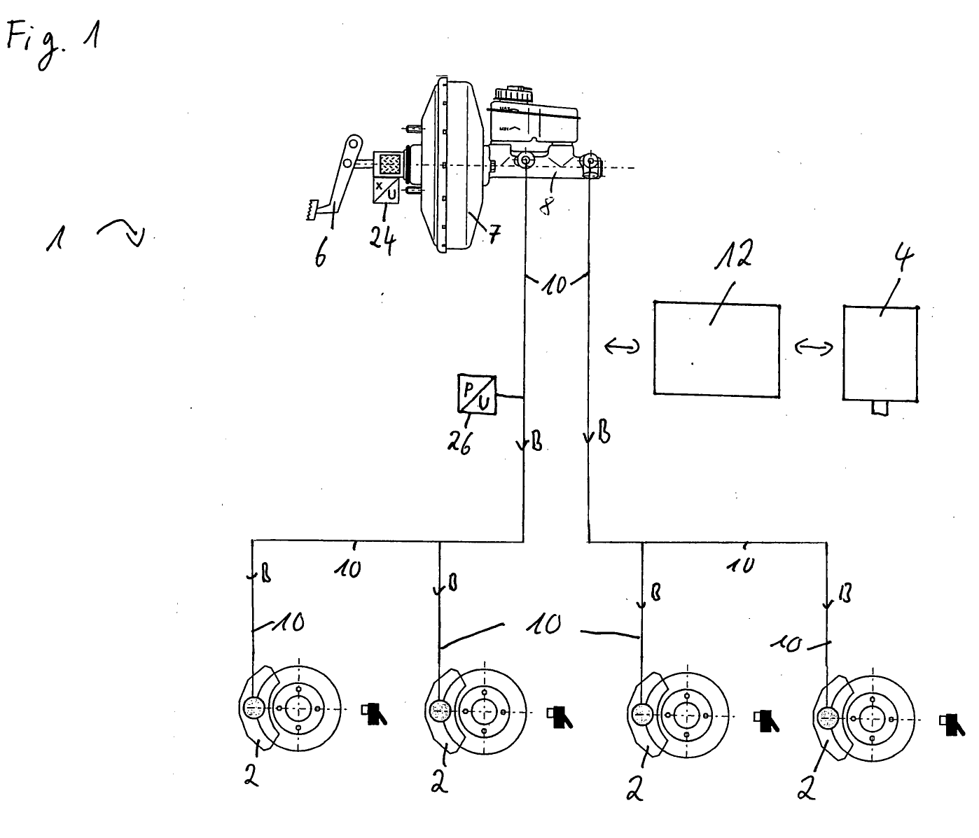

FIG. 1 illustrates a basic circuit diagram of a brake system 1 for a motor vehicle. Brake system 1 is a regenerative brake system 1 which, apart from four friction brakes 2, also includes an electric generator 4 for producing electric energy. The brake pressure required for the friction brakes 2 is produced by way of the brake pedal 6 and the brake booster 7 with the master brake cylinder 8. As this occurs, the master brake cylinder 8 conducts braking medium B through the hydraulic lines 10 to the friction brakes 2. The master brake cylinder 2 is configured as a tandem master cylinder to achieve an appropriate delivery rate. The brake system 1 is designed to provide great braking comfort because the motion of brake pedal 6 corresponds to the braking performance of the motor vehicle. To this effect, the brake system 1 is designed as a parallel regenerative brake system 1. The total deceleration of the motor vehicle in a braking operation is composed of deceleration components of generator 4 and friction brakes 2. To correspondingly actuate the generator 4, the brake system 1 includes a software module 12 presetting a nominal brake torque to the generator 4. The latter brake torque is determined from the total nominal deceleration and the deceleration component of the friction brakes 2 with the software module 12. The brake pedal travel or the position of the brake pedal 6, respectively, and the braking medium pressure of the braking medium B in the hydraulic lines 10 are taken into account as input quantities. The brake pedal travel is determined by means of the travel indicator 24 which is positioned at the brake pedal 6, while the braking medium pressure is measured at the hydraulic line 10 by means of pressure sensor 26.

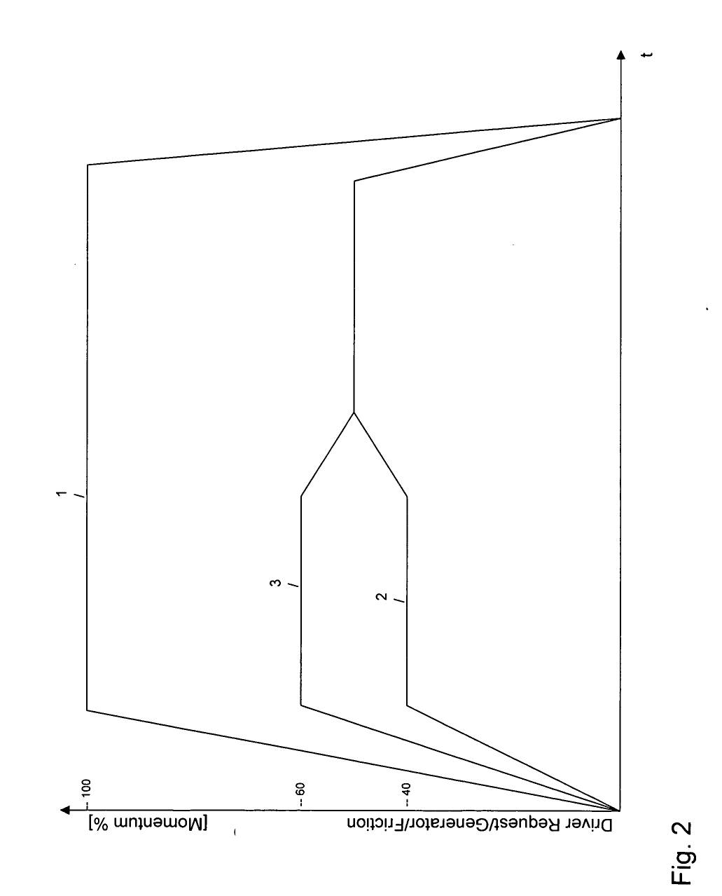

The control of the brake system 1 is explained in more detail in the light of a braking operation. Therefore, a braking operation with proportionate brake torques of generator 4 and friction brakes 2 is shown in FIG. 2 as a function of time. An initial speed of 100 km/h is made the basis in the braking operation. Curve 1 represents the braking request or the total nominal deceleration, respectively, which the driver introduces by way of the brake pedal 6. In this arrangement, the nominal deceleration of the brake at first rises linearly when the brake pedal 6 is depressed, stays constant during the braking operation, and is reduced again linearly to zero at the end by releasing the brake pedal 6.

Before the braking operation commences, the motor vehicle, in the absence of acceleration, is already decelerated by the generator 4 using the brake torque that corresponds to a deceleration of the motor vehicle of 0.1 g, which the driver feels to be an engine brake. This deceleration is not shown FIG. 2.

When the brake pedal 6 is depressed, both the brake torque of the generator 4 and that of the friction brakes 2 will rise linearly, and the brake torque component of the generator 4 amounts to 40 % (curve 2) and that of the friction brakes amounts to 60 % (curve 3) when the maximum total deceleration is reached.

The available brake torque of generator 4 will rise when 60 km/h are reached. However, the software module will limit the brake torque to a brake torque which corresponds to a proportionate deceleration of the motor vehicle by way of the generator 4 of roughly 0.15 g. The rise up to this maximum brake torque of the generator 4 to a component of 50 % of the total brake torque is controlled to be rising linearly. Simultaneously, the brake torque component of the friction brakes likewise drops to 50 %. When the brake pedal 6 is released, the brake torque components of both the friction brakes and the generator are reduced linearly to zero.

### List of Reference Numerals:

1 brake system
2 friction brake
4 generator
5 brake pedal
7 brake booster
8 master brake cylinder
10 hydraulic line
12 software module
24 travel indicator
26 pressure sensor
B braking medium

1-12. (canceled)

13. A method for controlling a brake system of a motor vehicle, the motor vehicle includes a parallel configuration of an electrically controllable generator and a number of hydraulic friction brakes, the method comprising:
determining a total nominal deceleration;
determining a nominal brake torque of the generator based on the determined total nominal deceleration; and
controlling the generator based on the nominal brake torque.

14. The method according to claim 13, wherein the brake torque of the generator is limited by a maximum brake torque in a selected speed range.

15. The method according to claim 14, wherein a range between 10 and 50 km/h is chosen as the speed range.

16. The method according to claim 14, wherein at the maximum brake torque for the generator (4) a torque is predetermined that corresponds to a contribution of the generator (4) to a total deceleration of roughly 0.15 g.

17. The method according to claim 14, wherein abrupt brake torque changes of the generator at fringes of the speed range are smoothed.

18. The method according to claim 13, wherein the generator is operated as soon as there is no positive acceleration of the motor vehicle.

19. The method according to claim 18, wherein in the absence of positive acceleration of the motor vehicle, the generator torque is preset to correspond to a contribution of the generator (4) to the total deceleration of approximately 0.1 g.

20. The method according to claim 13, wherein a total nominal deceleration is determined by way of a travel indicator of the brake pedal of the brake system.

21. The method according to claim 13, wherein a total nominal deceleration is determined by way of a pressure sensor which is positioned at a hydraulic line leading to a friction brake.

22. The method according to claim 13, wherein signals are used to determine the total nominal deceleration which are available to the brake system.

23. A software module for controlling a regenerative brake system of a motor vehicle, the motor vehicle includes a parallel configuration of an electrically controllable generator and a number of hydraulic friction brakes, the software module comprising:
code for determining a total nominal deceleration;
code for determining a nominal brake torque of the generator based on the determined total nominal deceleration; and
code for controlling the generator based on the nominal brake torque.
